(19) United States
(12) Patent Application Publication
(10) Pub. No.: US 2025/0116967 A1
(43) Pub. Date: Apr. 10, 2025

(54) COMPONENT OF A HOROLOGICAL MOVEMENT COMPRISING A JOINT CAPABLE OF BEING LOCKED

(71) Applicant: Montres Breguet S.A., L'Abbaye (CH)

(72) Inventor: Jérôme MACÉ, Le Pont (CH)

(73) Assignee: Montres Breguet S.A., L'Abbaye (CH)

(21) Appl. No.: 18/782,332

(22) Filed: Jul. 24, 2024

(30) Foreign Application Priority Data
Oct. 10, 2023 (EP) 23202753.2

(51) Int. Cl. G04B 15/14

(52) U.S. Cl. CPC G04B 15/14

(57) ABSTRACT

A component (10) of a horological movement, which component includes two arms (11) connected to each other by a pivot link, the component (10) being able to occupy an extended position and a folded position, in which folded position the arms (11) form a smaller angle than when the component (10) occupies the extended position, the component (10) further including a coupling mechanism configured to prevent any relative mobility between the two arms (11) when the component (10) occupies the extended position.

### CROSS REFERENCE TO RELATED APPLICATION

This application claims priority to European Patent Application No. 23202753.2 filed Oct. 10, 2023, the entire contents of which are incorporated herein by reference.

### TECHNICAL FIELD OF THE INVENTION

The invention relates to the field of watchmaking, and in particular to the components of a horological movement.

More particularly, the invention relates to a component of a horological movement, which component comprises an articulation capable of being locked.

### TECHNOLOGICAL BACKGROUND

Horological movements for watches, in particular horological movements including horological complications, i.e. mechanisms allowing indications other than the time and its divisions to be provided, typically include a large number of components, often several hundred, arranged in a volume of restricted dimensions.

The design of a horological movement is thus significantly limited by the available volume in which all of the components can be arranged.

Horological movement designers must also ensure that each component designed is able to withstand, over time, the mechanical stresses to which it is subjected, and that it can be manufactured repeatedly and as simply as possible while respecting dimensional tolerances. It must also be possible to assemble the component within the movement and to dismantle it as easily as possible for servicing operations.

The present invention relates to a component which overcomes all of the above-mentioned difficulties associated with the design of a component for a horological movement.

### SUMMARY OF THE INVENTION

To this end, the present invention relates to a component of a horological movement comprising two arms connected to each other by means of a pivot link. The component is able to occupy an extended position and a folded position, in which folded position the arms form a smaller angle than when the component occupies the extended position. The component further includes a coupling mechanism comprising snap fitting elements and being configured to prevent any relative mobility between the two arms when the component occupies the extended position.

In particular embodiments, the invention can further include one or more of the following features, which must be considered singly or according to any combination technically possible.

In particular embodiments, the snap fitting elements are formed by a catch arranged on one of the arms, and a resilient tab arranged on the other arm. Said resilient tab includes a recess in which the catch is intended to be housed when the component is in the extended position, so as to immobilise the arms relative to each other.

In particular embodiments, the resilient tab is configured to apply a resilient return force against the catch.

In particular embodiments, the catch and the recess are shaped so that the catch is released from the recess when the resilient tab is biased against a resilient return force.

In particular embodiments, the resilient tab is arranged between the catch and the arm carrying it, so as to have an angular range whose limits are defined by said catch and said arm.

In particular embodiments, the recess is arranged between a proximal portion and a distal portion of the resilient tab, the distal portion being intended to extend along an arc of a circle concentric with the axis of rotation of the arms or along a segment tangential to the axis of rotation of the arms.

In particular embodiments, the recess is shaped so as to constitute a stop preventing relative mobility of the arms in one direction of rotation, when the resilient tab is biased so as to release the catch from said recess.

In particular embodiments, the proximal portion of the resilient tab includes a segment via which it is in contact with the catch when the component is in the extended position, this segment being shaped so as to extend tangentially relative to the axis of rotation of the arms, along an axis passing through the centre of the catch when the latter is housed in the recess.

### BRIEF DESCRIPTION OF THE FIGURES

Other features and advantages of the invention will appear upon reading the following detailed description, which is given with reference to:

FIG. 1, which shows a perspective view of a component of a horological movement comprising an articulation capable of being locked according to a preferred example embodiment of the present invention;

FIG. 2, which shows a detailed front view of the component shown in FIG. 1.

It should be noted that the figure is not necessarily drawn to scale for reasons of clarity.

### DETAILED DESCRIPTION OF THE INVENTION

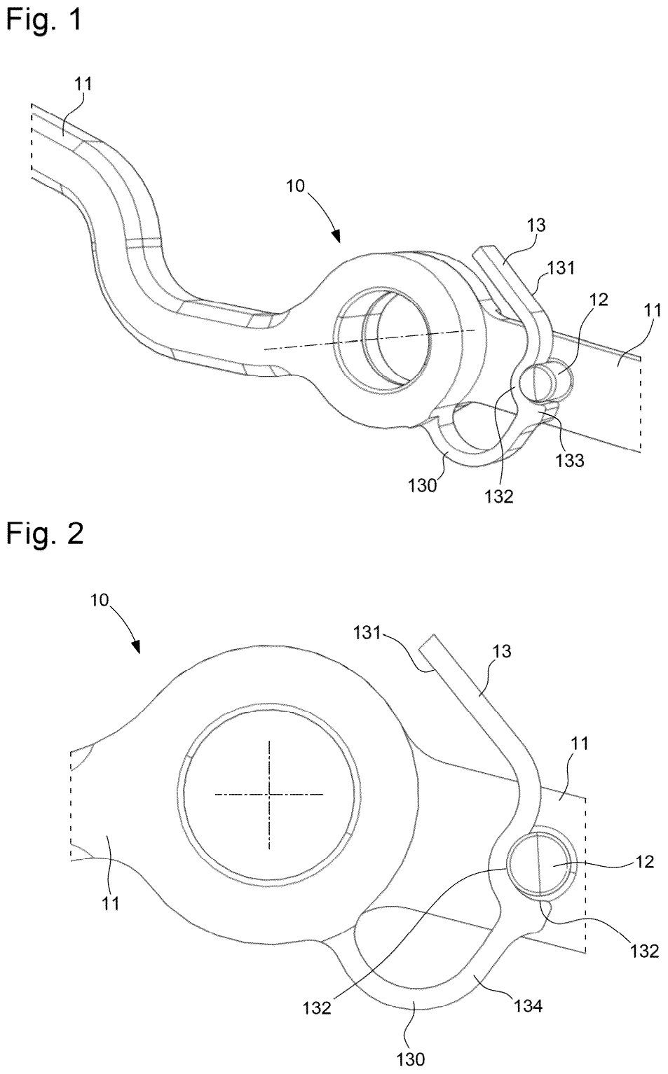

The present invention relates to a component 10 of a horological movement which can form, in examples of application, a motion-transmitting member such as a rocker, a lever, a shaft or any other elongate member, i.e. any other member extending along a longitudinal axis. The component 10 extends along a longitudinal axis which can be rectilinear, curvilinear or of any shape, as shown in FIG. 1.

The component 10 comprises an articulation connecting two arms 11 to each other by means of a pivot link. This feature allows the component 10 to be shaped to take an extended position and a folded position, in which folded position the arms 11 form a smaller angle than when the component 10 occupies the extended position. This folded position can advantageously allow a watchmaker to mount the component 10 more easily within the horological movement or to remove it more easily.

The arms 11 are connected to each other by a pivot which can be produced by any technical solution available to a person skilled in the art. In particular, in the example embodiment shown in FIGS. 1 and 2, each of the arms 11 has, at an interface end, a through-hole in which a rod forming a pivot can be engaged, which rod is, for example, stopped translatably by a head forming a stop opposite a nut with which the rod cooperates via a threaded portion.

This pivot can optionally constitute a pivot for the component 10, in which case the axis of rotation of the arms 11 in relation to each other and the axis of rotation of the component 10 coincide.

The rotational mobility of the arms 11 in relation to each other can advantageously be eliminated by a coupling mechanism with which the component 10 is equipped, so that one of the arms 11 can transmit a force, for example a torque, to the other arm 11. More specifically, the arms 11 are immobilised relative to each other when the component 10 is in the extended position, as illustrated in FIGS. 1 and 2.

In particular, the coupling mechanism comprises snap fitting elements. For example, a catch 12 is arranged on one of the arms 11, and a resilient tab 13 is arranged on the other arm 11. The resilient tab 13 can include a proximal portion 130 and a distal portion 131 between which a recess 132 is arranged, as shown in FIG. 2. The catch 12 is intended to be housed in the recess 132 so as to establish a rigid connection between the two arms 11, and as a result prevent any relative mobility between said arms 11.

In the preferred example embodiment of the invention, the resilient tab 13 is configured so as to apply a resilient return force against the catch 12. This feature makes it possible to ensure permanent contact between the resilient tab 13 and the catch 12, so as to ensure, on the one hand, that the latter engages in the recess 132 when the component 10 moves from the folded position into the extended position and, on the other hand, that the catch 12 remains engaged in the recess 132 when the component 10 occupies the extended position. The direction of the resilient return force is preferably radial relative to the axis of rotation of the arms 11, so as to pass through the centre of the catch 12 and to be aligned with the longitudinal axis of the arm 11 carrying same.

The resilient tab 13 could also conceivably not exert any force on the catch 12 and comprise snap fitting elements, such as a reduction in the cross-section of the recess 132 at an opening for engaging the catch 12, making it possible to ensure that the catch 12 is held radially in the recess 132.

Advantageously, the catch 12 and the recess 132 are shaped in such a way that their cooperation is only broken by a user biasing the resilient tab 13 against the resilient return force. In particular, only the deformation of the resilient tab 13 by biasing the distal portion 131 towards the axis of rotation of the arms 11 in the example shown in FIGS. 1 and 2, allows the catch 12 to be removed from the recess 132, which then allows the arms 11 to pivot relative to each other.

Moreover, in this example embodiment of the invention, the resilient tab 13 is arranged between the catch 12 and the arm 11 carrying it, so as to have an angular range whose limits are defined by said catch 12 and said arm 11.

When the component 10 occupies the folded position and the arms 11 are pivoted relative to each other, the catch 12 is intended to slide against the distal portion 131 of the resilient tab 13. In order to allow the arms 11 to move rotatably when the catch 12 is not engaged in the recess 132, the distal portion 131 is intended to extend along an arc of a circle concentric with the axis of rotation of the arms 11 or along a segment tangential to the axis of rotation of the arms 11, as shown in the detailed view in FIG. 2.

To summarise, when the component 10 is in the folded position, the arms 11 can pivot relative to each other through a predefined angular range.

Advantageously, the recess 132 can be shaped so as to form a stop preventing the relative mobility of the arms 11 in one direction when the component 10 moves from the extended position into the folded position, i.e. when the resilient tab 13 is biased so as to release the catch 12. In other words, the recess 132 is shaped so as to limit the rotation of the arms 11 relative to each other according to the predefined angular range. To this end, the recess 132 has a protrusion 133 forming a stop. Thanks to this feature, the catch 12 cannot come into contact with the proximal portion 130 of the resilient tab 13.

The proximal portion 130 of the resilient tab 13 includes a segment 134 via which it is in contact with the catch 12 when the component 10 is in the extended position. This segment 134 is preferably shaped so as to extend tangentially relative to the axis of rotation of the arms 11, along an axis passing through the centre of the catch 12 when the latter is housed in the recess 132. This feature ensures optimum distribution of mechanical stresses when forces are transmitted between the arms 11.

More generally, it should be noted that the implementations and embodiments considered above have been described by way of non-limiting examples, and that other alternatives are consequently possible.

For example, a second recess capable of receiving and engaging the catch 12 can be arranged on the distal portion 131 of the resilient tab 13 so as to generate a stable position of the arms 11 relative to each other, i.e. a position without any degree of mobility, when the component 10 occupies the folded position.

1. A component (10) of a horological movement, comprising:
two arms (11);
a pivot link connecting the two arms, the component (10) being able to occupy an extended position and a folded position, in which folded position the arms (11) form a smaller angle than when the component (10) occupies the extended position; and
a coupling mechanism comprising snap fitting elements and configured to prevent any relative mobility between the two arms (11) when the component (10) occupies the extended position.

2. The component (10) according to claim 1, wherein the snap fitting elements are formed by a catch (12) arranged on one of the arms (11), and a resilient tab (13) arranged on the other arm (11), said resilient tab (13) including a recess (132) in which the catch (12) is intended to be housed when the component (10) is in the extended position, so as to immobilise the arms (11) relative to each other.

3. The component (10) according to claim 2, wherein the resilient tab (13) is configured so as to apply a resilient return force against the catch (12).

4. The component (10) according to claim 2, wherein the catch (12) and the recess (132) are shaped so that the catch (12) is released from the recess (132) when the resilient tab (13) is biased against a resilient return force.

5. The component (10) according to claim 2, wherein the resilient tab (13) is arranged between the catch (12) and the arm (11) carrying it, so as to have an angular range whose limits are defined by said catch (12) and said arm (11).

6. The component (10) according to claim 2, wherein the recess (132) is arranged between a proximal portion (130) and a distal portion (131) of the resilient tab (13), the distal portion (131) being configured to extend along an arc of a circle concentric with the axis of rotation of the arms (11) or along a segment tangential to the axis of rotation of the arms (11).

7. The component (10) according to claim 2, wherein the recess (132) is shaped so as to constitute a stop preventing relative mobility of the arms (11) in one direction of rotation, when the resilient tab (13) is biased so as to release the catch (12) from said recess (132).

8. The component (10) according to claim 6, wherein the proximal portion (130) of the resilient tab (13) includes a segment (134) via which it is in contact with the catch (12) when the component (10) is in the extended position, this segment (134) being shaped so as to extend tangentially relative to the axis of rotation of the arms (11), along an axis passing through the centre of the catch (12) when the latter is housed in the recess (132).
